(19) United States
(12) Patent Application Publication
(10) Pub. No.: US 2016/0319755 A1
(43) Pub. Date: Nov. 3, 2016

(54) CONTROL SYSTEM OF INTERNAL COMBUSTION ENGINE

(71) Applicant: TOYOTA JIDOSHA KABUSHIKI KAISHA, Toyota-shi (JP)

(72) Inventor: Masahiro WANIBE, Nagoya-shi (JP)

(73) Assignee: TOYOTA JIDOSHA KABUSHIKI KAISHA, Toyota-shi (JP)

(21) Appl. No.: 15/139,594

(22) Filed: Apr. 27, 2016

(30) Foreign Application Priority Data
Apr. 28, 2015 (JP) 2015-091514
Oct. 27, 2015 (JP) 2015-211181

(51) Int. Cl. F02D 41/00; F02M 26/34; F02B 37/18; F02M 26/04

(52) U.S. Cl. CPC F02D 41/0007; F02M 26/04; F02M 26/34; F02B 37/18; F02D 2041/0017

(57) ABSTRACT

A control system of an internal combustion engine is provided. The engine includes a turbocharger, a bypass passage, a wastegate valve, an exhaust-gas recirculation passage, and an exhaust-gas recirculation valve. The control system includes a valve closing detector and an electronic control unit. The valve closing detector is configured to detect start of an operation to close the wastegate valve. The electronic control unit is configured to start an operation to close the exhaust-gas recirculation valve when the start of the operation to close the wastegate valve is detected by the valve closing detector, such that both of the wastegate valve and the exhaust-gas recirculation valve are closed during supercharging by the turbocharger.

### INCORPORATION BY REFERENCE

The disclosure of Japanese Patent Applications Nos. 2015-091514 and 2015-211181 filed on Apr. 28, 2015 and Oct. 27, 2015 including the specification, drawings and abstract is incorporated herein by reference in its entirety.

### BACKGROUND OF THE INVENTION

1. Field of the Invention

The invention relates to a control system of an internal combustion engine provided with a turbocharger and an exhaust-gas recirculation system.

2. Description of Related Art

An internal combustion engine equipped with a turbocharger having an exhaust-gas turbine is known (see, for example, Japanese Patent Application Publication No. 2012-97639 (JP 2012-97639 A)). The engine described in JP 2012-97639 A has a bypass passage that communicates a portion of an exhaust passage located upstream of the exhaust-gas turbine in the direction of exhaust gas flow, with a portion of the exhaust passage located downstream of the exhaust-gas turbine, and a wastegate valve that blocks the bypass passage. The engine described in JP 2012-97639 A also has an exhaust-gas recirculation (EGR) system that recirculates exhaust gas in the exhaust passage into an intake passage. The EGR system includes an EGR passage that communicates with the exhaust passage and intake passage of the engine, and an EGR valve that blocks the EGR passage.

In the internal combustion engine provided with the turbocharger and the EGR system, since the intake air pressure (so-called intake manifold pressure) in a portion of the intake passage located downstream of a compressor n the direction of intake air flow is increased, during supercharging by the turbocharger, some of the intake air in the intake passage may flow back through the EGR passage and leak into the exhaust passage, due to the increased intake manifold pressure. In order to avoid the leakage of the intake air, it is considered to close the EGR valve when the intake manifold pressure is increased due to supercharging by the turbocharger.

### SUMMARY OF THE INVENTION

It takes some time since the operation to close the EGR valve is started, until the EGR valve is placed in a state (closed state) in which the EGR passage is blocked by the EGR valve. Therefore, even if the operation to close the EGR valve is started when the intake manifold pressure is increased, leakage of the intake air into the exhaust passage via the EGR passage may take place before the EGR valve is placed in the closed state.

This invention provides a control system of an internal combustion engine, which can favorably curb leakage of intake air into an exhaust passage via an exhaust-gas recirculation passage.

A control system of an internal combustion engine according to one aspect of the invention is provided. The internal combustion engine includes a turbocharger, a bypass passage, a wastegate valve, an exhaust-gas recirculation passage, and an exhaust-gas recirculation valve. The turbocharger including an exhaust-gas turbine provided in an exhaust passage of the internal combustion engine. The bypass passage communicates a portion of the exhaust passage located upstream of the exhaust-gas turbine in a direction of exhaust gas flow with a portion of the exhaust passage located downstream of the exhaust-gas turbine. The wastegate valve is configured to open and close the bypass passage. The exhaust-gas recirculation passage communicates the exhaust passage with an intake passage of the internal combustion engine. The exhaust-gas recirculation valve is configured to open and close the exhaust-gas recirculation passage. The control system includes a valve closing detector and an electronic control unit. The valve closing detector is configured to detect start of an operation to close the wastegate valve. The electronic control unit is configured to start an operation to close the exhaust-gas recirculation valve when the start of the operation to close the wastegate valve is detected by the valve closing detector, such that both of the wastegate valve and the exhaust-gas recirculation valve are closed during supercharging by the turbocharger.

According to the control system according to the above aspect of the invention, when the start of the operation to close the wastegate valve is detected, the operation to close the exhaust-gas recirculation (EGR) valve can be started, without waiting for a subsequent increase of the intake air pressure. Therefore, the EGR valve can be placed in the closed state, before the intake manifold pressure is increased to such a high level that leakage of intake air via the EGR passage would occur if the EGR valve is in an open state. Accordingly, the leakage of the intake air into the exhaust passage via the EGR passage can be favorably curbed, during supercharging by the turbocharger.

The control system according to the above aspect of the invention may further include a pressure detector configured to detect an intake air pressure in a portion of the intake passage located downstream of a compressor of the turbocharger in a direction of intake air flow. The electronic control unit may be configured to change an opening of the exhaust-gas recirculation valve, using a predetermined opening that is different from an opening of a fully closed valve as a opened-valve-side limit opening, when the intake air pressure detected by the pressure detector is equal to or lower than a predetermined pressure during the operation to close the exhaust-gas recirculation valve. The electronic control unit may be configured to change the opening of the exhaust-gas recirculation valve to the opening of the fully closed valve, when the intake air pressure detected by the pressure detector is higher than the predetermined pressure during the operation to close the exhaust-gas recirculation valve.

The earlier the EGR valve is placed in the closed state, the shorter the period of time for which exhaust gas is recirculated into the intake passage via the EGR passage; therefore, the amount of exhaust gas recirculated into the intake passage (the EGR amount) is reduced.

According to the control system as described above, when the intake manifold pressure is not so high during the operation to close the EGR valve, namely, when exhaust gas can be recirculated into the intake passage via the EGR passage, and there is no possibility of leakage of intake air into the exhaust passage via the EGR passage, the opening of the EGR valve is changed to an opening that is equal to or smaller than the predetermined opening that is different from the opening of the fully closed valve (the predetermined opening or an opening that is smaller than the predetermined opening). Since the EGR valve can be opened, using the predetermined opening as the opened-valve-side limit opening, the exhaust gas can be recirculated into the intake passage via the EGR passage. Therefore, the EGR amount can be increased, as compared with the system in which the opening of the EGR valve is changed to that of the fully closed valve, irrespective of the intake manifold pressure. Furthermore, since the EGR valve can be closed to the predetermined opening, the opening of the EGR valve can be promptly changed to that of the fully closed valve when the EGR valve is subsequently operated so as to be placed in the closed state. Then, according to the above-described system, when the intake manifold pressure is high during the operation to close the EGR valve, the opening of the EGR valve can be changed to that of the fully closed valve, so that leakage of intake air into the exhaust passage via the EGR passage can be favorably curbed.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view showing the general configuration of a control system of an internal combustion engine according to a first embodiment of the invention;

FIG. 2 is a flowchart illustrating the procedure of an EGR valve closing process of the first embodiment;

FIG. 3 is a timing chart showing one example of implementation of the EGR valve closing process of the first embodiment;

FIG. 4 is a flowchart illustrating the procedure of an EGR valve closing process according to a second embodiment of the invention; and

FIG. 5 is a timing chart showing one example of implementation of the EGR valve closing process of the second embodiment.

### DETAILED DESCRIPTION OF EMBODIMENTS

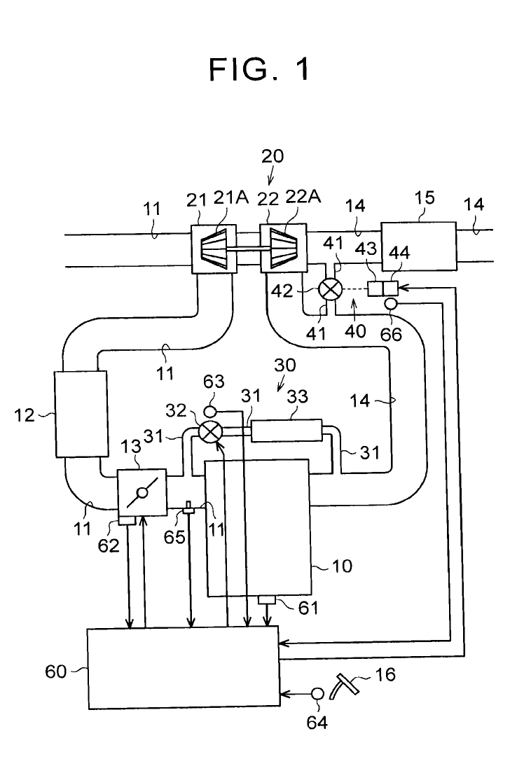

A control system of an internal combustion engine as a first embodiment of the invention will be described. As shown in FIG. 1, in an intake passage 11 of the internal combustion engine 10, a compressor 21 of a turbocharger 20, an intercooler 12 that cools intake air, and a throttle valve 13 that changes the passage cross-sectional area of the intake passage 11 are mounted, in this order as viewed from the upstream side of the intake air flow. In an exhaust passage 14 of the engine 10, an exhaust-gas turbine 22 of the turbocharger 20 and an exhaust-gas treatment device 15 that cleans exhaust gas are mounted, in this order as viewed from the upstream side of the exhaust gas flow. In the turbocharger 20, a compressor wheel 21A provided in the compressor 21 and a turbine wheel 22A provided in the exhaust-gas turbine 22 are coupled to each other.

The internal combustion engine 10 is also equipped with an EGR system 30 for returning some of exhaust gas in the exhaust passage 14 as exhaust-gas recirculation (EGR) gas to the intake passage 11. The EGR system 30 has an EGR passage 31 as a passage through which the EGR gas is recirculated. The EGR passage 31 communicates a portion of the exhaust passage 14 located upstream of the exhaust-gas turbine 22 in the direction of flow of exhaust gas, with a portion of the intake passage 11 located downstream of the throttle valve 13 in the direction of flow of intake air. In the EGR passage 31, an EGR valve 32 for controlling the amount of the EGR gas that passes through the EGR passage 31, and an EGR cooler 33 for cooling the EGR gas, are mounted. Through operation control of the EGR valve 32, the amount of the EGR gas that passes through the EGR passage 31, namely, the EGR amount of the EGR system 30, is controlled.

The internal combustion engine 10 is further provided with a wastegate valve mechanism 40 that permits exhaust gas to flow while bypassing the exhaust-gas turbine 22. The wastegate valve mechanism 40 includes a bypass passage 41 that communicates a portion of the exhaust passage 14 located upstream of the exhaust-gas turbine 22, with a portion of the exhaust passage 14 located downstream of the exhaust-gas turbine 22, and a wastegate valve 42 operable to block the bypass passage 41. A diaphragm-type actuator 43 that operates under a differential pressure applied to a diaphragm incorporated therein is connected to the wastegate valve 42, and a differential pressure control valve 44 for adjusting the differential pressure applied to the diaphragm is connected to the actuator 43. Through operation control of the differential pressure control valve 44, the opening of the wastegate valve 42 is controlled, so that the amount of exhaust gas discharged via the bypass passage 41 is controlled.

The internal combustion engine 10 is provided with various sensors for detecting operating conditions of the engine 10. The sensors include, for example, a speed sensor 61 that detects the rotational speed (engine speed NE) of an output shaft (not shown) of the engine 10, an opening sensor 62 that detects the opening (throttle opening TA) of the throttle valve 13, and an opening sensor 63 that detects the opening (EGR opening EA) of the EGR valve 32. The above-indicated various sensors also include an accelerator position sensor 64 that detects the operation amount (accelerator operation amount ACC) of an accelerator operating member 16, and a pressure sensor 65 as a pressure detector that detects the intake air pressure (intake manifold pressure P) in a portion of the intake passage 11 located downstream of the throttle valve 13 in the intake air flow. Other sensors, such as an opening sensor 66 that detects the opening (wastegate valve opening WA) of the wastegate valve 42, are also provided.

The internal combustion engine 10 is provided with peripheral equipment in the form of an electronic control unit 60 that includes a microcomputer, for example. The electronic control unit 60 receives output signals of various sensors, performs various computations based on the output signals, and performs various controls associated with operation of the engine 10, such as operation control of the throttle valve 13, EGR valve 32, and the wastegate valve 42, according to the results of computations. In this embodiment, the electronic control unit 60 corresponds to the above-indicated valve closing detector.

The operation control of the throttle valve 13 (throttle control) is carried out in the following manner. Specifically, a control target value (target throttle opening Tta) of the opening of the throttle valve 13 is calculated based on the accelerator operation amount ACC and the engine speed NE. Then, the operation of the throttle valve 13 is controlled so that the target throttle opening Tta and the actual throttle opening TA become equal to each other.

The operation control of the EGR valve 32 (EGR control) is carried out in the following manner. Specifically, a control target value (target EGR opening Tea) of the opening of the EGR valve 32 is calculated based on the engine load and the engine speed NE. Then, the operation of the EGR valve 32 is controlled so that the target EGR opening Tea and the actual EGR opening EA become equal to each other. In this embodiment, a value (=GA/NE) obtained by dividing the intake air amount GA of the engine 10 calculated based on the intake manifold pressure P and the engine speed NE by the engine speed NE is used as the engine load. The intake air amount GA, fuel injection amount Q, or a value (=Q/NE) obtained by dividing the fuel injection amount Q by the engine speed NE, for example, may also be used as the engine load.

In this embodiment, in an engine operating region in which supercharging is not performed by the turbocharger 20 (more specifically, in a low-load low-speed operating region in which the intake air amount GA is small and the engine speed NE is low), the EGR valve 32 is opened, and the EGR system 30 performs recirculation of the EGR gas into the intake passage 11. On the other hand, in an engine operating region in which supercharging is performed by the turbocharger 20 (more specifically, in a high-load operating region in which the intake air amount GA is large, or a high-speed operating region in which the engine speed NE is high), the EGR valve 32 is closed, and the EGR system does not perform recirculation of the EGR gas into the intake passage 11.

The operation control of the wastegate valve 42 (wastegate valve control) is carried out in the following manner. Specifically, a control target value (target intake manifold pressure Tp) of the intake manifold pressure P is calculated, based on the accelerator operation amount ACC and the engine speed NE. Then, the operation amount of the differential pressure control valve 44 is feedback-controlled, and the opening of the wastegate valve 42 is adjusted, so that the target intake manifold pressure Tp and the intake manifold pressure P become equal to each other. In this embodiment, in the engine operating region in which supercharging is performed by the turbocharger 20 (more specifically, in the high-load operating region in which the intake air amount is large, or the high-speed operating region in which the engine speed NE is high), the wastegate valve 42 is closed, and discharge of exhaust gas via the bypass passage 41 is stopped. On the other hand, in the engine operating region in which supercharging is not performed by the turbocharger 20 (more specifically, in the low-load, low-speed operating region in which the intake air amount is small and the engine speed NE is low), the wastegate valve 42 is opened, and exhaust gas is permitted to be discharged via the bypass passage 41.

In this embodiment, through execution of the EGR control, the EGR valve 32 is closed in the operating region in which supercharging is performed by the turbocharger 20 and the intake manifold pressure P is increased. As a result, some of the intake air in the intake passage 11 is less likely or unlikely to flow back through the EGR passage 31 under the increased intake manifold pressure P, and leak into the exhaust passage 14.

In this connection, it takes some time since the operation to close the EGR valve 32 is started, until the EGR valve 32 is placed in a state (closed state) in which the valve 32 blocks the EGR passage 31. Therefore, in the case where the intake manifold pressure P is rapidly increased when the vehicle is accelerated, for example, even if the operation to close the EGR valve 32 is started at the time when the engine is brought into an operation region in which the intake manifold pressure P is increased, the intake manifold pressure P rises to a high level by the time when the EGR valve 32 is placed in the closed state, and the intake air may leak into the exhaust passage 14 via the EGR passage 31. The leakage of the intake air into the exhaust passage 14 may undesirably result in various problems, such as occurrence of misfiring in the engine 10, deterioration of the driveability, and poor acceleration.

In the internal combustion engine 10 as described above, when the engine operating region shifts from a non-supercharging region to a supercharging region, such as when the accelerator operating member 16 is operated so as to accelerate the vehicle, the wastegate valve 42 shifts from a state (open state) in which the bypass passage 41 is not blocked by the valve 42, to a state (closed state) in which the bypass passage 41 is blocked.

In view of the above point, in this embodiment, it is determined whether the operation to close the wastegate valve 42 is started, in response to the transition of the engine operating region from the non-supercharging region to the supercharging region. Then, when the start of the operation to close the wastegate valve 42 is detected, the operation to close the EGR valve 32 is started. Through execution of the wastegate valve control and the EGR control as described above, the wastegate valve 42 and the EGR valve 32 are closed at the time of supercharging by the turbocharger 20.

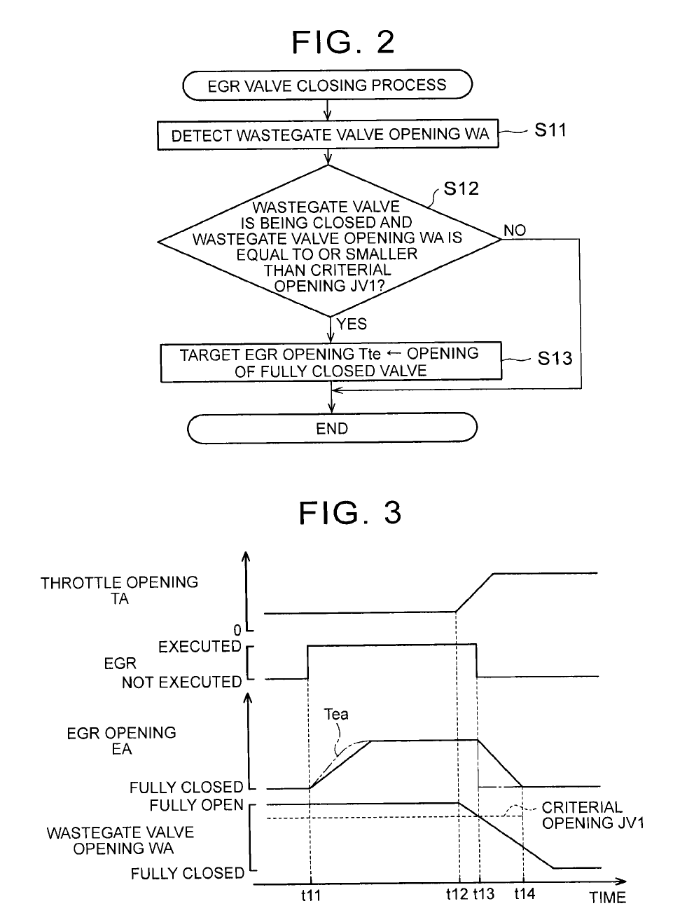

In the following, a process (EGR valve closing process) for closing the EGR valve 32 in the above manner will be described in detail. FIG. 2 shows the procedure of the EGR valve closing process. A control routine illustrated in the flowchart of FIG. 2, which schematically indicates the procedure of the EGR valve closing process, is executed by the electronic control unit 60, actually as an interrupt routine executed at given time intervals. Also, the EGR valve closing process is carried out as a part of processing under the EGR control.

As shown in FIG. 2, initially in this routine, the wastegate valve opening WA is detected by the opening sensor 66 (step S11), and it is determined whether the following condition (A) and condition (B) are both satisfied (step S12). The condition (A) is that the wastegate valve 42 is being closed. More specifically, the wastegate valve opening WA is currently changing to a closed-valve-side opening or a smaller opening. The condition (B) is that the opening of the wastegate valve 42, which was larger than a criterial opening JV1, has become equal to or smaller than the criterial opening JV1 More specifically, the wastegate valve opening WA detected in the last cycle of this routine was larger than the criterial opening JV1, and the wastegate valve opening WA detected in the this cycle of the routine is equal to or smaller than the criterial opening JV1. As the criterial opening JV1, an opening that is slightly smaller than the maximum opening (the opening of the fully open valve) within an opening control range is determined in advance.

If both of the conditions (A) and (B) are satisfied (step S12: YES), it is determined that the operation to close the wastegate valve 42 has been started, and the minimum opening (the opening of the fully closed valve) within an opening control range is set as the target EGR opening Tea (step S13). In this case, the opening of the fully closed valve is set as the target EGR opening Tea, until the EGR valve 32 is placed in the closed state.

On the other hand, if one or both of the conditions (A) and (B) is/are not satisfied (step S12: NO), step S13 is not executed, and the current cycle of this routine is finished. In the following, the operation caused by execution of the EGR valve closing process will be described.

In the example shown in FIG. 3, before time t11, the engine 10 is in a stable operating state in which the throttle opening TA is constant. Also, the EGR valve 32 is in the closed state, and recirculation of exhaust gas via the EGR passage 31 is not carried out. Further, since the engine 10 is in an operating region in which supercharging is not performed by the turbocharger 20, the wastegate valve 42 is in a fully open state.

At time t11, if the engine 10 is brought into an operating region in which the EGR valve 32 is to be opened, the EGR valve 32 is opened. Then, after time t11, the target EGR opening Tea (indicated by the one-dot chain line in FIG. 3) is calculated based on the engine operating conditions, and the operation of the EGR valve 32 is controlled based on the target EGR opening Tea.

Subsequently, at time t12, the accelerator operating member 16 is operated for acceleration of the vehicle. Thus, after time t12, the throttle opening TA is increased. At this time, since the target intake manifold pressure Tp increases as the accelerator operation amount AC increases, the operation to close the wastegate valve 42 is started, so as to increase the actual intake manifold pressure P in accordance with the increase of the target intake manifold pressure Tp.

At time t13, the wastegate valve opening WA, which was larger than the criterial opening JV1, becomes equal to or smaller than the criterial opening JV1 (namely, becomes equal to the criterial opening JV1 or an opening that is closer to the opening of the closed valve than the criterial opening JV1). At this time, the above-indicated conditions (A) and (B) are both satisfied, and the start of the operation to close the wastegate valve 42 is detected. Since the turbocharger 20 is highly likely to actually start supercharging after time t13, the opening of the fully closed valve is set as the target EGR opening Tea. In this manner, the operation to close the EGR valve 32 is started. Thus, in this embodiment, when the start of the operation to close the wastegate valve 42 is detected, the operation to close the EGR valve 32 can be started, without waiting for a subsequent increase of the intake manifold pressure P.

Then, after time t13, the EGR valve 32 is promptly closed to the opening of the fully closed valve. Therefore, the EGR valve 32 can be placed in the closed state, at a point in time (time t14) before the intake manifold pressure P is increased to such a high level that leakage of intake air into the exhaust passage 14 via the EGR passage 31 would occur if the EGR valve 32 is in the open state. Thus, according to this embodiment, it is possible to favorably curb leakage of intake air into the exhaust passage 14 via the EGR passage 31, during supercharging by the turbocharger 20.

As described above, an effect as described below is obtained according to this embodiment. (1) During supercharging by the turbocharger 20, leakage of intake air into the exhaust passage 14 via the EGR passage 31 can be favorably curbed.

A control system of an internal combustion engine according to a second embodiment of the invention will be described. In particular, a difference of the second embodiment from the first embodiment will be mainly described.

This embodiment and the first embodiment are different from each other only in the procedure of the EGR valve closing process. In the following, the EGR valve closing process of this embodiment will be described. In the following description, the same reference numerals are assigned to the same components as those of the first embodiment, and detailed description of these components will not be provided.

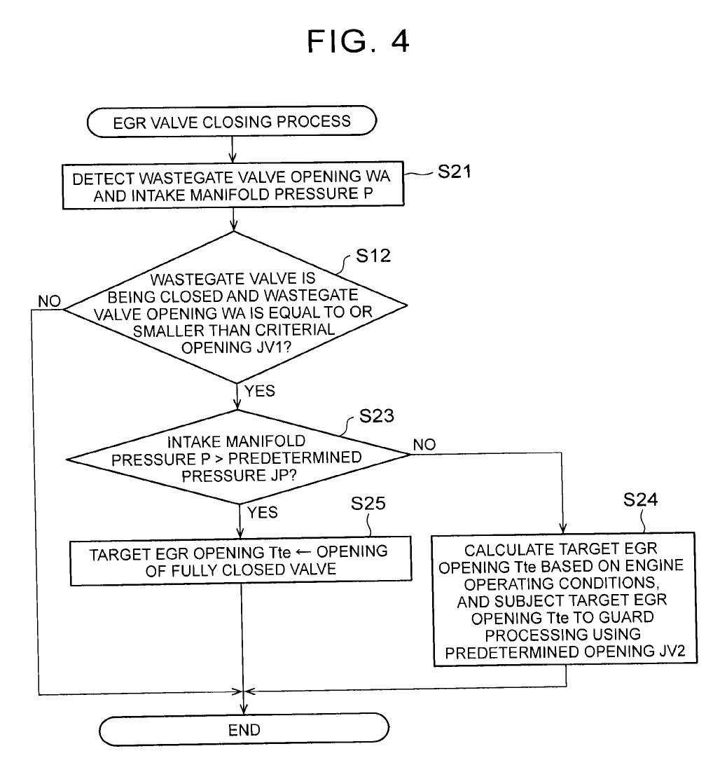

FIG. 4 illustrates the procedure of the EGR valve closing process. A control routine illustrated in the flowchart of FIG. 4, which schematically indicates the procedure of the EGR valve closing process, is executed by the electronic control unit 60, actually as an interrupt routine executed at given time intervals. The EGR valve closing process is carried out as a part of processing under the EGR control.

As shown in FIG. 4, initially in this routine, the wastegate valve opening WA is detected by the opening sensor 66, and the intake manifold pressure P is detected by the pressure sensor 65 (step S21). Then, it is determined whether the above-indicated conditions (A) and (B) are both satisfied (step S12).

If the conditions (A) and (B) are both satisfied (step S12: YES), it is determined that the operation to close the wastegate valve 42 has been started, and it is determined whether the intake manifold pressure P is higher than a predetermined pressure JP (step S23). As the predetermined pressure JP, a certain pressure that is slightly lower than the atmospheric pressure is determined in advance, and stored in the electronic control unit 60.

If the intake manifold pressure P is equal to or lower than the predetermined pressure JP, the target EGR opening Tea is calculated based on the engine load and the engine speed Ne, and the target EGR opening Tea is subjected to guard processing using a predetermined opening JV2 that is different from the opening of the fully closed valve as a opened-valve-side limit opening (step S24). More specifically, if the target EGR opening Tea calculated based on the engine load and the engine speed NE is equal to or larger than the predetermined opening JV2, the predetermined opening JV2 is determined as a new target EGR opening Tea. On the other hand, if the target EGR opening Tea calculated based on the engine load and the engine speed NE is smaller than the predetermined opening JV2, the target EGR opening Tea thus calculated is determined as it is as the target EGR opening Tea.

In this embodiment, a suitable control range of the wastegate valve opening WA is obtained based on the results of various experiments and simulation. When the wastegate valve opening WA is in the control range thus obtained, the wastegate valve 42 permits the exhaust gas flow to be routed via the bypass passage 41, and the EGR valve 32 can be promptly brought into the fully closed state when the intake manifold pressure P becomes higher than the predetermined pressure JP, such that leakage of intake air into the exhaust passage 14 can be appropriately curved. The opening corresponding to the upper limit of this control range is stored in advance as the above-indicated predetermined opening JV2 in the electronic control unit 60.

On the other hand, if the intake manifold pressure P is higher than the predetermined pressure JP, the minimum opening (the opening of the fully closed valve) in the opening control range is set as the target EGR opening Tea (step S25). In this case, the opening of the fully closed valve is set as the target EGR opening Tea, until the EGR valve 32 is placed in the fully closed state.

When one or both of the conditions (A) and (B) is/are not satisfied (step S12: NO), the electronic control unit 60 finishes the current cycle of this routine, without executing step S23 through step S25.

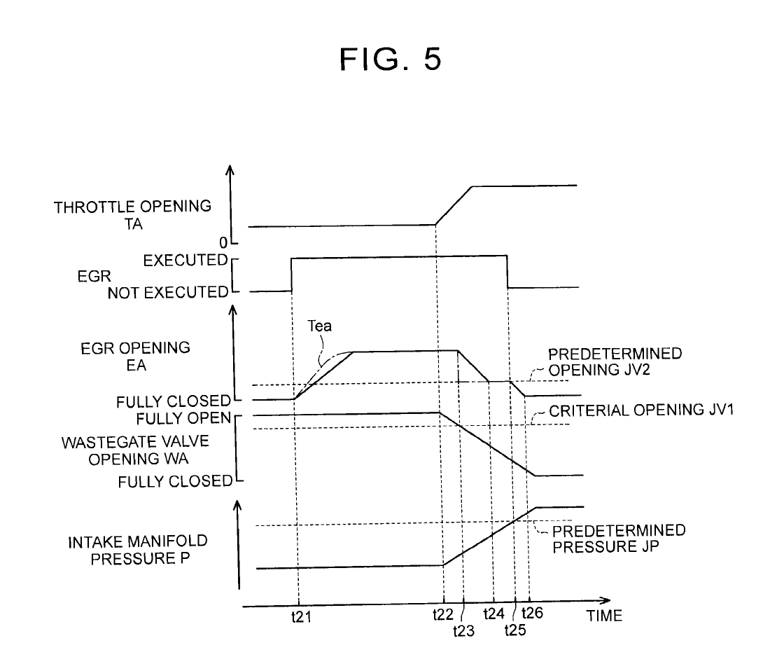

In the following, the operation caused by execution of the EGR valve opening process will be described. In the example shown in FIG. 5, before time t21, the engine 10 is in a stable operating state in which the throttle opening TA is constant. Also, the EGR valve 32 is in the closed state, and recirculation of exhaust gas via the EGR passage 31 is not carried out. Further, since the engine 10 is in an operating region in which supercharging is not performed by the turbocharger 20, the wastegate valve 42 is in a fully open state. Also, since supercharging is not performed by the turbocharger 20, the intake manifold pressure P is at a low level.

If the engine 10 is brought into an operating region in which the EGR valve 32 is to be opened, at time t21, the EGR valve 32 is opened. Then, after time t21, the target EGR opening Tea (indicated by the one-dot chain line in FIG. 5) is calculated based on the engine operating conditions, and the operation of the EGR valve 32 is controlled based on the target EGR opening Tea.

Subsequently, at time t22, the accelerator operating member 16 is operated for acceleration of the vehicle. Thus, after time t22, the throttle opening TA is increased. At this time, since the target intake manifold pressure Tp increases as the accelerator operation amount ACC increases, the operation to close the wastegate valve 42 is started, so as to increase the actual intake manifold pressure P in accordance with the increase of the target intake manifold pressure Tp.

At time t23, the wastegate valve opening WA, which was larger than the criterial opening JV1, becomes equal to or smaller than the criterial opening JV1. At this time, the above-indicated conditions (A) and (B) are both satisfied, and the start of the operation to close the wastegate valve 42 is detected. Since the turbocharger 20 is highly likely to actually start supercharging after time t23, the EGR valve 32 starts being closed. More specifically, since the intake manifold pressure P is lower than the predetermined pressure JP, the opening of the EGR valve 32 is changed using the predetermined opening JV2 as the closed-valve-side limit opening. As a result, in this embodiment, after the EGR valve 32 is closed to the predetermined opening JV2 (time t23-t24), the opening of the EGR valve 32 is kept at the predetermined opening JV2 (after time t24).

The earlier the EGR valve 32 is placed in the closed state, the shorter the period of time for which exhaust gas is recirculated into the intake passage 11 via the EGR passage 31; therefore, the amount of exhaust gas recirculated into the intake passage 11 (the EGR amount) is reduced.

According to this embodiment, when the intake manifold pressure P is not so high during the operation to close the EGR valve 32, namely, when exhaust gas can be recirculated into the intake passage 11 via the EGR passage 31, and there is no possibility of leakage of intake air into the exhaust passage 14 via the EGR passage 31, the opening of the EGR valve 32 is changed to an opening that is equal to or smaller than the predetermined opening JV2. At this time, since the EGR valve 32 can be opened, using the predetermined opening JV2 as the opened-valve-side limit opening, exhaust gas can be recirculated into the intake passage 11 via the EGR passage 31. Therefore, the EGR amount can be increased, as compared with the system in which the opening of the EGR valve 32 is changed to that of the fully closed valve, irrespective of the intake manifold pressure P.

Then, if the intake manifold pressure P becomes higher than the predetermined pressure JP at time t25, the opening of the fully closed valve is set as the target EGR opening Tea. As a result, after time t25, the EGR valve 32 is promptly closed to the opening of the fully closed valve. In this embodiment, since the EGR valve 32 can be closed to an opening equal to or smaller than the predetermined opening JV2 while the intake manifold pressure P is lower than the predetermined pressure JP, the opening of the EGR valve 32 can be promptly changed to that of the fully closed valve when the intake manifold pressure P becomes equal to or higher than the predetermined pressure JP, and the EGR valve 32 is operated so as to be placed in the closed state.

By closing the EGR valve 32 in the above-described manner, it is possible to place the EGR valve 32 in the closed state, at a point in time (time t26) before the intake manifold pressure P is increased to such a high level that leakage of intake air into the exhaust passage 14 via the EGR passage 31 would occur if the EGR valve 32 is in the open state. Thus, according to this embodiment, leakage of intake air into the exhaust passage 14 via the EGR passage 31 can be favorably curbed, during supercharging by the turbocharger 20.

As explained above, according to this embodiment, an effect as described below at (2) is obtained, in addition to the effect as described above at (1). (2) When the intake manifold pressure P is equal to or lower than the predetermined pressure JP during the operation to close the EGR valve 32, the opening of the EGR valve 32 is changed, using the predetermined opening JV2 different from the opening of the fully closed valve as the opened-valve-side limit opening. When the intake manifold pressure P is higher than the predetermined pressure JP during the operation to close the EGR valve 32, the EGR valve 32 is closed to the opening of the fully closed valve. Therefore, the EGR amount can be increased, as compared with the system in which the opening of the EGR valve 32 is changed to that of the fully closed valve, irrespective of the intake manifold pressure P. Furthermore, the EGR valve 32 can be closed to an opening that is equal to or larger than the predetermined opening JV2 when the intake manifold pressure P is equal to or lower than the predetermined pressure JP during the operation to close the EGR valve 32; therefore, when the EGR valve 32 is subsequently operated to be placed in the closed state, the opening of the EGR valve 32 can be promptly changed to that of the fully closed valve. Then, when the intake manifold pressure P is high during the operation to close the EGR valve 32, the opening of the EGR valve 32 is changed to that of the fully closed valve, and leakage of intake air into the exhaust passage 14 via the EGR passage 31 can be favorably curbed.

Each of the above-described embodiments may be changed as described below and implemented. It may be determined that the operation to close the wastegate valve 42 has been started, based on change of the wastegate valve opening WA from the opening of the fully open valve. More specifically, in step S12 of the EGR valve closing routine, it may be determined whether the wastegate valve opening WA detected during execution of the last cycle of this routine is the opening of the fully open valve, and the wastegate valve opening WA detected during execution of this cycle of the same routine is smaller than the opening of the fully open valve.

The start of the operation to close the wastegate valve 42 can be detected based on parameters, such as a control command value of the differential pressure control valve 44 and a differential pressure of the diaphragm of the actuator 43, other than the wastegate valve opening WA. For example, it may be determined that the operation to close the wastegate valve 42 has been started, based on change of the control command value of the differential pressure control valve 44 from a value that is smaller than a predetermined value (i.e., a value at which the wastegate valve opening WA is larger than the criterial opening JV1) to a value that is equal to or larger than the predetermined value (i.e., a value at which the wastegate valve opening WA is equal to or smaller than the criterial opening JV1). It may also be determined that the operation to close the wastegate valve 42 has been started, based on change of the differential pressure of the diaphragm of the actuator 43 from a value that is smaller than a predetermined value (i.e., a value at which the wastegate valve opening WA is larger than the criterial opening JV1) to a value that is equal to or larger than the predetermined value (i.e., a value at which the wastegate valve opening WA is equal to or smaller than the criterial opening JV1).

As the actuator of the wastegate valve 42, an electric rotary motor may be employed.

What is claimed is:

1. A control system of an internal combustion engine, the internal combustion engine including a turbocharger, a bypass passage, a wastegate valve, an exhaust-gas recirculation passage, and an exhaust-gas recirculation valve, the turbocharger including an exhaust-gas turbine provided in an exhaust passage of the internal combustion engine, the bypass passage communicating a portion of the exhaust passage located upstream of the exhaust-gas turbine in a direction of exhaust gas flow with a portion of the exhaust passage located downstream of the exhaust-gas turbine, the wastegate valve being configured to open and close the bypass passage, the exhaust-gas recirculation passage communicating the exhaust passage with an intake passage of the internal combustion engine, the exhaust-gas recirculation valve being configured to open and close the exhaust-gas recirculation passage, the control system comprising:
a valve closing detector configured to detect start of an operation to close the wastegate valve, and
an electronic control unit configured to start an operation to close the exhaust-gas recirculation valve when the start of the operation to close the wastegate valve is detected by the valve closing detector, such that both of the wastegate valve and the exhaust-gas recirculation valve are closed during supercharging by the turbocharger.

2. The control system according to claim 1, further comprising:
a pressure detector configured to detect an intake air pressure in a portion of the intake passage located downstream of a compressor of the turbocharger in a direction of intake air flow, wherein
the electronic control unit is configured to change an opening of the exhaust-gas recirculation valve, using a predetermined opening that is different from an opening of a fully closed valve as a opened-valve-side limit opening, when the intake air pressure detected by the pressure detector is equal to or lower than a predetermined pressure during the operation to close the exhaust-gas recirculation valve, and
the electronic control unit is configured to change the opening of the exhaust-gas recirculation valve to the opening of the fully closed valve, when the intake air pressure detected by the pressure detector is higher than the predetermined pressure during the operation to close the exhaust-gas recirculation valve.
